(19) United States
(12) Patent Application Publication
(10) Pub. No.: US 2003/0048813 A1
(43) Pub. Date: Mar. 13, 2003

(54) Method for mapping and multiplexing constant bit rate signals into an optical transport network frame

(75) Inventors: Danny Lahav, Kfar Saba (IL); Liviu Altarovici, Tel-Aviv (IL); Amir Dabby, Sitriya (IL)

Correspondence Address: DR. MARK FRIEDMAN LTD., C/O BILL POLKINGHORN, DISCOVERY DISPATCH, 9003 FLORIN WAY, UPPER MARLBORO, MD, 20772, US

(73) Assignee: Optix Networks Inc.

(21) Appl. No.: 10/233,574

(22) Filed: Sep. 4, 2002

Related U.S. Application Data
(60) Provisional application No. 60/316,961, filed on Sep. 5, 2001.

(51) Int. Cl. H04J 14/00

(52) U.S. Cl. 370/537; 370/395.43

(57) ABSTRACT

A method for mapping and multiplexing of constant bit rate (CBR) signals into optical transport network (OTN) frames is provided. The method, in addition, enables the transportation of data from a plurality of SONET/SDH clients through a single OTN frame. The preferred method thereby enables efficient adoption of SONET/SDH legacy equipment by OTN networks.

This application claims priority from application No. 60/316,961, filed Sep. 5, 2001, by the same inventors. The Provisional Application Serial No. 60/316,961 is incorporated herein by reference for all it discloses.

References

| Patents | | |
|---|---|---|
| 6,058,119 | May 2000 | Engbersen, et al. |
| 5,872,780 | February 1999 | Demiray, et al. |
| 5,267,236 | November 1993 | Stephenson, Jr. et al. |
| 5,132,970 | July 1992 | Urbansky |
| 4,998,242 | March 1991 | Upp |

### OTHER REFERENCES

ITU-T G.709 “Network Node Interface for optical transport network (OTN)” standard (see: http://www.itu.int//TU-T/).

### FIELD AND BACKGROUND OF THE INVENTION

1. Field of the Invention

The present invention relates generally to optical communication networks, and more particularly, to the mapping and multiplexing of CBR signals into OTN frames.

2. Description of the Related Art

SONET/SDH is now a mature digital transport technology, established in virtually every country in the world. When SONET/SDH was first conceived in the early 1980s, telecommunications traffic was predominantly voice based. During the last years there has been a burst in the demand for bandwidth driven mainly by Internet access, e-commerce and mobile telephony. This increase in demand has, so far, been satisfied through a combination of increased line rates of time division multiplexing (TDM) and transmitting multiple wavelengths through a single fiber, using dense wave division multiplexing (DWDM) in high speed optical networks. However, as such a network evolves to higher line rates, the physical limitations of the transport medium (optical fiber) become critical. Furthermore, there remains an over-riding requirement to control the cost of providing and improving the level of service to the users.

Optical transport network (OTN) was conceived in 2001 to overcome the drawbacks of SONET/SDH networks. The OTN capabilities and facilities are published as a new standard, known as ITU-G.709 “Network node interface for the optical transport network (OTN)” (hereinafter “G.709 standard”). The OTN standard is based on the SONET/SDH G.975 standard, however, some key elements have been added to improve performance and reduce cost. These include management of optical channels in the optical domain, forward error correction (FEC) to improve error performance and enable longer optical spans, and a standardized method for managing optical wavelengths (channels) end to end without the need for processing of the payload signal.

Reference is now made to FIG. 1 where an illustration of a typical OTN frame 10 is shown. An OTN frame consists of three distinct areas: overhead 11, optical payload unit (OPU) 12, and forward error control (FEC) 13. The overhead area 11 is used for the operation, administration, and maintenance functions. The OPU area 12 is used for customers' data, and in particular, this area includes data from a plurality of clients to be transported by means of the OTN frame 10. The OPU area consists of two sub-areas OPU overhead (OH) and OPU payload data. The OPU OH is located at columns 15 and 16 rows 1-4, while the OPU payload data is located at columns 17-3,824 rows 1-4. The OPU area includes the justification control (JC) bytes (not shown), the negative justification opportunity (NJO) byte (not shown), and the positive justification opportunity (PJO) byte (not shown). The NJO, JC and PJO are filled with data during a justification process, if such a process is performed. The justification process, as can be seen, for example, in the G.709 standard is used to compensate for data losses when performing asynchronous mapping. The FEC area is used for error detection and correction. The size of the OTN frame is four rows, each row having 4,080 columns. The size of a column is one byte. Data is transmitted serially beginning at the top left, first row followed by the second row and so forth. There are three line rates currently defined in OTN: 1) 2.5Gbps—optical channel transport unit 1 (OTU1); 2) 10Gbps-OTU2; and, 3) 40Gbps—OTU3. The actual rates of OTU1, OTU2, and OTU3 are 2.66Gbps, 10.7Gbps, and 43Gbps respectively.

Constant bit rate (CBR) signals typically refer to SONET and SDH signals. There are five different line rates defined for CBR signals: 150 Mbps, (hereinafter “CBR150M”), 622 Mbps (hereinafter “CBR622M”), 2.5Gbps (hereinafter “CBR2G5 ”), 10Gbps (hereinafter “CBR10G”), and 40Gbps (hereinafter “CBR40G”). The CBR150M, CBR622M, CBR2G5, CBR10G, and CBR40G signals are defined in the SONET/SDH standards OC-3/STM-1, OC-12/STM-4, OC-48/STM-16, OC-192/STM-64, and OC-786/STM-256 correspondingly.

There are known mapping techniques only for mapping of CBR2G5, CBR10G, and CBR40G into OTU1, OTU2, and OTU3 respectively. Namely, only transportation of a single CRB2G5 signal over an OTU1 frame, a single CBR10G signal over an OTU2 frame, and a single CBR40G signal over an OTU3 frame, are enabled. These techniques are described in detail in the OTN G.709 standard. However, the current techniques do not enable multiplexing low rate CBR signals into high rate OTN frames. For example, the capability for multiplexing four CBR2G5 signals into a single OTU2 frame is not provided by these techniques. This limitation results in waste of available bandwidth resources and limits the types of data that can be transported over an OTN network.

There are known techniques, referenced above, for multiplexing and mapping SONET/SDH signals. However, these techniques do not enable integration of such processes into OTN network architecture.

Therefore, it would be an advantageous to have a means for multiplexing and mapping of CBR signals of various line rates into OTU frames of various rates, such that efficient adoption of SONET/SDH legacy equipment is enabled by OTN networks.

### SUMMARY OF THE INVENTION

According to the present invention there is provided a method for multiplexing and mapping constant bit rate (CBR) signals of various line rates into OTU frames of various rates. Furthermore, a mapper is provided that enables mapping and multiplexing CBR signals into OTN frames.

In contrast to the known prior art techniques, the preferred method of the present invention provides a means to integrate CBR signals into OTN network architecture, thereby enabling efficient adoption of SONET/SDH legacy equipment by OTN networks.

The method for multiplexing and mapping CBR signals of various line rates into OTU frames of various rates, according to a preferred embodiment of the present invention, is as follows:

a) dividing an optical payload unit (OPU) area of the OTN frame into groups of tributary slots (TSs);

b) allocating the TSs to the clients;

c) inserting an overhead of each CBR signal into an OPU overhead area; and

d) mapping a byte of each CBR signal into the TSs allocated to each CBR signal.

According to an additional embodiment of the present invention, a method is provided for multiplexing constant bit rate (CBR) signals transported by means of four different clients, into a single OTN frame.

According to a further embodiment of the present invention, a method is provided for multiplexing constant bit rate (CBR) signals transported by means of sixteen different clients, into a single OTN frame.

According to an additional embodiment of the present invention, a method is provided for demultiplexing the CBR signals that were multiplexed using the method described above. The demultiplexing technique requires the steps of:

i. finding at least one overhead associated to the CBR signal;

ii. combining data spread over a number of OTN frames, according to the associated overhead(s); and

iii. affixing said the overhead(s) associated with the CBR signal to a combined signal, to form the complete CBR signal.

### BRIEF DESCRIPTION OF THE DRAWINGS

The principles and operation of a system and a method according to the present invention may be better understood with reference to the drawings, and the following description, it being understood that these drawings are given for illustrative purposes only and are not meant to be limiting, wherein:

FIG. 1 is an illustration of a typical OTN frame structure.

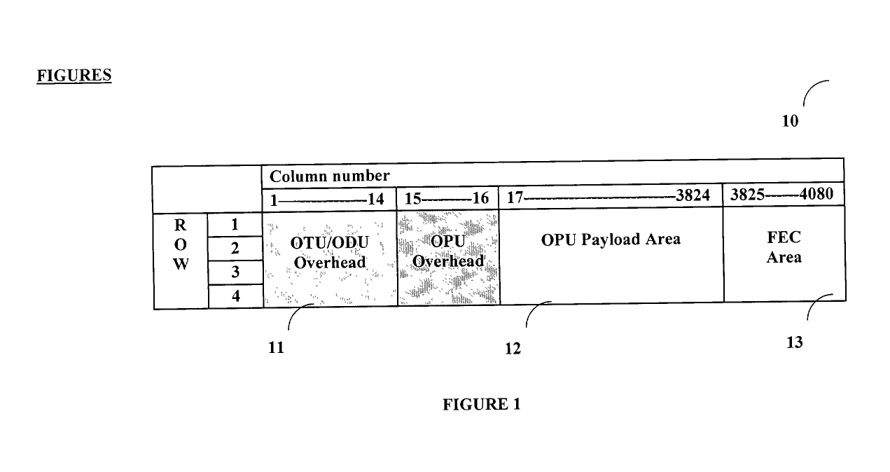

FIG. 2 is an illustration of the allocation of TSs in an OPU payload area.

FIG. 3 is an exemplary flowchart describing the mapping process in accordance with one embodiment of the present invention.

FIG. 4 is an example of mapping four CBR signals into a single OTU frame in accordance with one embodiment of this invention.

FIG. 5 is an example of mapping sixteen CBR signals into a single OTU frame in accordance with one embodiment of this invention.

### DESCRIPTION OF THE PREFERRED EMBODIMENT

The present invention relates to a system and method for mapping and multiplexing constant bit rate (CBR) signals into a variety of OTU frames, such as OTU1, OTU2 and OTU3 frames. In addition, the present method provides a means for transporting data from a plurality of SONET/SDH clients through a single OTN frame. For the purpose of the present disclosure, the CBR150M, CBR622M, CBR2G5, CBR10G, CBR40G, and any other CBR signal are defined as “CBR signals” and OTU1, OTU2, OTU3, and any other OTU frame shall be defined as “OTU frame”.

The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

The principles and operation of a system and a method according to the present invention may be better understood with reference to the drawings and the accompanying description, it being understood that these drawings are given for illustrative purposes only and are not meant to be limiting, wherein:

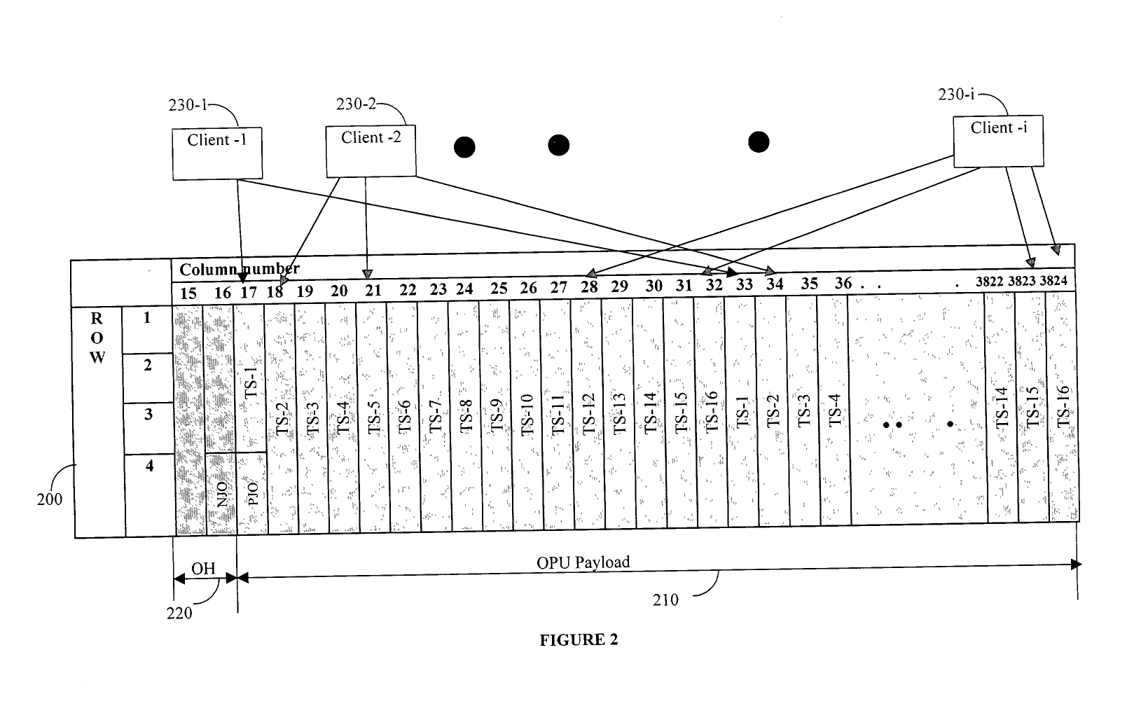

Reference is now made to FIG. 2 where an illustration of OPU 200 tributary slots (TSs) allocation is shown, as defined in the G.709 standard. However, in order to map the CBR signals into OPU 200, the present method divides the OPU payload area 210 into groups of a plurality of TSs (hereinafter “TS group”) and assigns selected TSs to different clients, i.e. the CBR signals. Each tributary slot is interleaved within OPU payload area 210. The size of each tributary slot is one column by four rows, where each column is one byte. In a non-limiting example of possible TSs allocation having “n” different clients, the method allocates the TSs in the following fashion: the TSs located at columns n*j+17 are allocated to the 1^{st} client, the TSs positioned at columns n*j+18 are allocated to the 2^{nd} client, the TSs positioned at columns n*j+19 are allocated to the 3^{rd} client, and so forth. For example, when n=4 then the TSs located at columns 4*j+17 are allocated to the 1^{st} client, the TSs positioned at columns 4*j+18 are allocated to the 2^{nd} client, the TSs positioned at columns 4*j+19 are allocated to the 3^{rd} client and the TSs positioned at columns 4*j+20 are allocated to the 4^{th} client. The index “j” is an integer starting at zero and ending at 237 (which is the number of the TS groups in a single frame), which refers to the specific allocation of TSs to clients. The parameter “n” represents the number of clients. It should be appreciated that a weighted allocation is also possible, wherein each client is allocated a different number of TSs located at unequal intervals from each other.

It should be further noted that the CBR signals, according to the present invention, are assigned to the TSs with respect to their rates. For instance, in order to map four CBR2G5 into OTU2, each CBR signal consumes a quarter (¼) of the allocated TSs. Hence, in the above example, the allocation procedure enables four CBR2G5 signals to be mapped into a single OTU2, and similarly four CBG10G signals can be mapped to a single CBR40G etc. Similarly, a combination of various CBR signals can be mapped into a larger OTU frame. It should be further noted that the first allocation begins at row one, column seventeen, which is the beginning of the OPU payload.

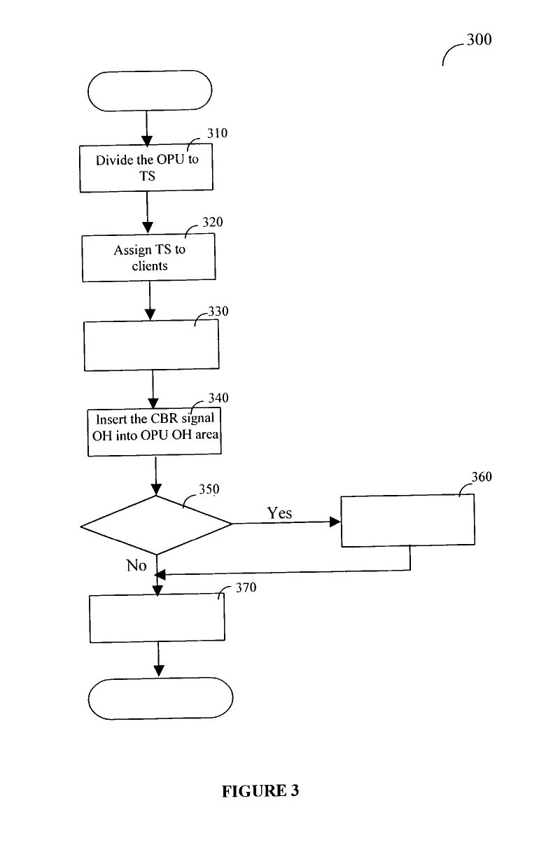

Reference is now made to FIG. 3 where a non-limiting exemplary flowchart 300 describing the method for mapping and multiplexing CBR signals into an OTN frame is shown. At step 310, the OPU payload area 210 is divided into M TSs groups, each TSs group including a plurality of TSs, namely TS-1 through TS-N. Typically, “M” equals to two hundred and thirty eight (238) and “N” equals to sixteen, but these variables are not limited to the present numbers. Each TS may include data from a different client.

At step 320, the TSs are assigned to the different clients, where each client transports CBR signals that have the same rate. However, since CBR signals transported by different clients may have different rates, at step 330, the value of the four least significant bits (LSB) of the multi-frame alignment signal (MFAS) is obtained. The MFAS byte is found in the OTN frame at row one column seven. The value of the MFAS byte is incremented for each frame thereby providing a multi-frame structure with 256 frames. The four LSB of the MFAS represents the current index of the OTU frame, starting from one and ending at sixteen.

At step 340, the client indexed by the MFAS inserts its CBR signal associated overhead into OPU OH area 220. For example, if the value of the MFAS is five, then client number five is chosen to manipulate its CBR signal overhead.

At step 350, it is determined whether a justification is required. A justification is required when performing asynchronous mapping, if the clock of the chosen client is not synchronized with the OTU clock. If it is determined that a justification is required, then the process continues at step 360 or otherwise, at step 370.

At step 360, the justification is performed in order to compensate for data losses, resulting from unsynchronized clocks. If the client clock is faster than the OTU clock, then a data byte from the client is mapped into the negative justification opportunity (NJO) byte, located at OPU OH area 220. On the other hand, if the OTU clock is faster than the client clock, then the positive justification opportunity (PJO) byte, located at OPU payload area 210, is filled with zeros. The justification process, detailed in the G.709 standard, is incorporated herein by reference for all it discloses.

At step 370, each client maps a byte of its CBR signal into each of the TSs allocated for this client. Each client is allowed to map its CBR signal only to the TSs assigned for it. The mapping of the CBR is controlled by means of a mapper. The mapper is capable of coordinating the data loading by the different clients to the TSs assigned to the clients.

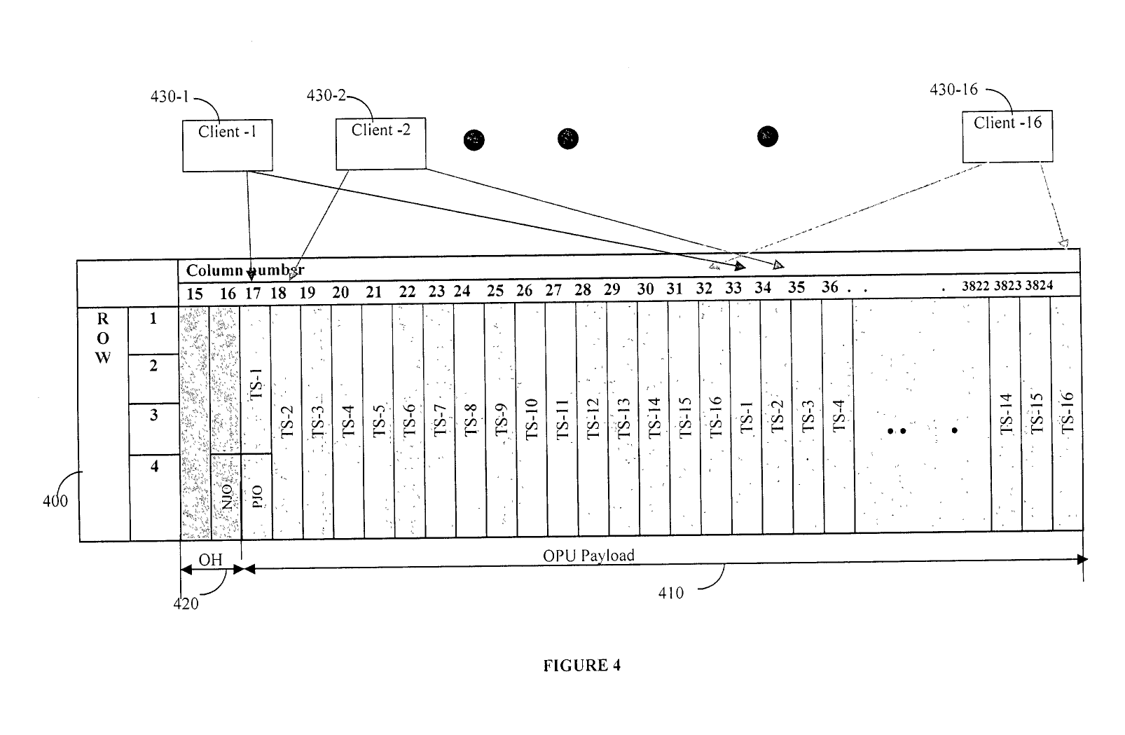

Reference is now made to FIG. 4 that demonstrates the mapping of sixteen CBR signals into an OTU frame, in accordance with an embodiment of the present invention. FIG. 4 shows the resultant OPU 400. The CBR signals are transported by means of sixteen different clients 430-1 through 430-16. The OPU payload area 410 is divided into 238 groups of sixteen TSs, TS-1 through TS-16. In the course of the mapping process, each of clients 430 loads the data of its CBR signal into the TSs, positioned at intervals of sixteen TSs from each other. Such an interval may be used in order to maintain a jitter structure required for the mapping. Any interval, however, may be chosen for the positioning of the CBR signals. For instance, client 430-1 maps its data into TS-1 located at columns 16*j+17 client 410-2 maps its data into TS-2 located at columns 16*j+18, and likewise mapping clients 430-3 through 430-16, where “j” is an integer starting at zero and ending at 237. In each OTU frame, a single client 430 inserts the associated overhead data of its CBR signal into OPU OH area 420. Hence, a multi-frame structure of at least sixteen OTU frames is required to transport sixteen CBR signals. A person skilled in the art could easily adapt the description made herein to map, for example, sixteen CBR150M signals into a single OTU1 frame, sixteen CBR622M signals into a single OTU2 frame, sixteen CBR2G5 signals into a single OTU3 frame, or any other possible combination.

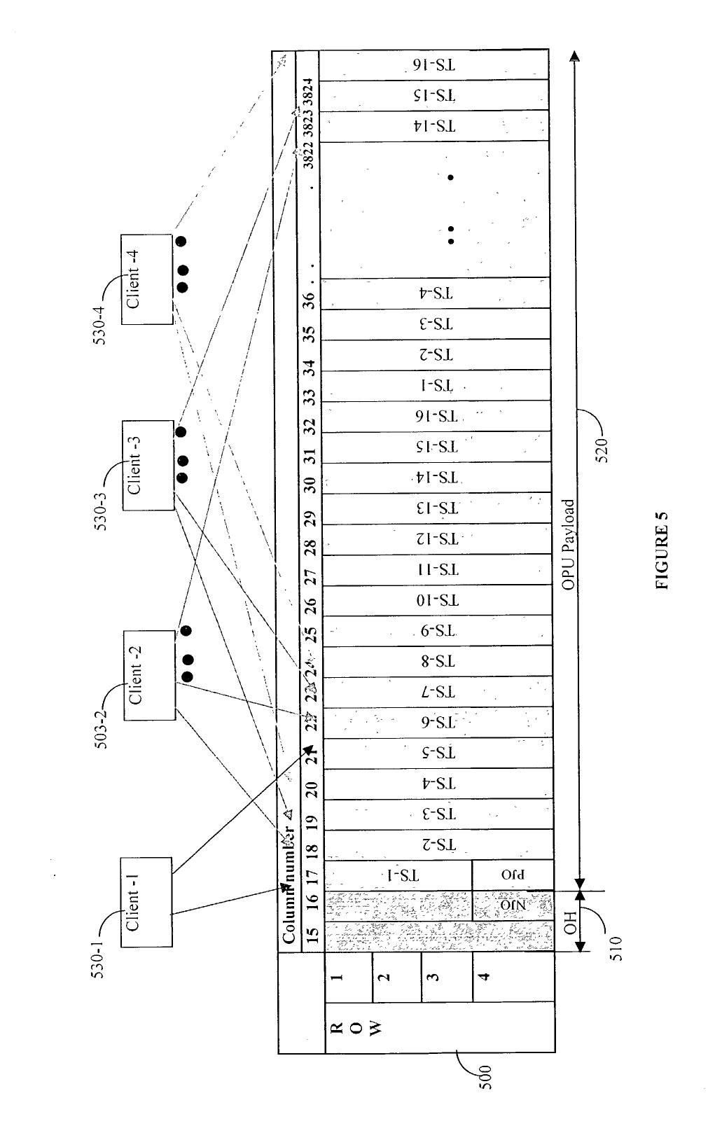

Reference is now made to FIG. 5 that demonstrates the mapping of four CBR signals into an OTU frame, in accordance with an additional embodiment of the present invention. FIG. 5 shows the resultant OPU 500. The CBR signals are transported by means of four different clients 530-1 through 530-4. The OPU payload area 510 is divided into 238 groups of sixteen TSs, TS-1 through TS-16. In the course of the mapping process, each client 530 loads the data of its CBR signal, into the TSs positioned at intervals of four TSs from each other. Such an interval may be used in order to maintain a jitter structure required for the mapping. Any interval, however, may be chosen for the positioning of the CBR signals. For instance, client 530-1 maps its data into the TS- 1, TS-5, TS-9, and TS-13 located at columns 4*j+17, client 510-2 maps the data of its CBR signal into TS-2, TS-6, TS-10, and TS-14 located at columns 4*j+18, and likewise for mapping clients 530-3 and 530-4. In each frame, a single client 530 inserts the associated overhead data of its CBR signal into OPU OH area 520. Hence, a multi-frame structure of at lease four OTU frames is required to transport four different CBR signals. A person skilled in the art could easily adapt the description made herein to map, for example, four CBR622M signals into a single OTU1 frame, four CBR2G5 signals into a single OTU2 frame, four CBR10G signals into a single OTU3 frame, or any other possible combination.

### Alternate Embodiments

While the invention described above describes how to map sixteen or four different clients into a single OTU frame, a person skilled in the art could easily use the method to map any number of clients into a single OTU frame.

In accordance with one embodiment of the invention, a demultiplexing technique is suggested for the purpose of demultiplexing the CBR signals that were multiplexed using the method described herein. Generally, the CBR signals are multiplexed at the transmitter side, and demultiplexed at the receiver side. The demultiplexing technique requires the following steps: First, finding at least one overhead associated with the CBR signal, from a plurality of OTN frames. Second, combining the data spread over a number of OTN frames according to the overhead(s) located, i.e., the multi frames structure. Third, affixing the overhead(s) associated with the CBR signal to a combined signal, thereby re-forming the CBR signal in is entirely.

The present invention may have a particular use in architectures that allow for different combinations of the SONET/SDH protocol with the emerging OTN protocol. One example of such architecture is provided in U.S. patent application Ser. No. 10/189,560, entitled “Combined SONET/SDH and OTN Architecture”, by Danny Lahav, et al., assigned to common assignee and which is hereby incorporated by reference for all that it discloses. The mapping method referred to enables mapping and multiplexing SONET and SDH signals into OTN frames, while such signals are transferred through the integrated architecture.

The foregoing description of the embodiments of the invention has been presented for the purposes of illustration and description. It is not intended to be exhaustive or to limit the invention to the precise form disclosed. It should be appreciated that many modifications and variations are possible in light of the above teaching. It is intended that the scope of the invention be limited not by this detailed description, but rather by the claims appended hereto.

What is claimed is

1. A method for mapping and multiplexing constant bit rate (CBR) signals, transported by a plurality of clients, into an optical transport network (OTN) frame, the method comprising the steps of:
a) dividing an optical payload unit (OPU) area of the OTN frame into groups of tributary slots (TSs);
b) allocating said TSs to the clients;
c) inserting an associated overhead of each CBR signal into an OPU overhead area; and
d) mapping a byte of each CBR signal into said TSs allocated to each said CBR signal.

2. The method of claim 1, further comprising, after step c):
i. determining whether a justification for compensating for data losses is required; and
ii. if said justification is required, performing a justification process.

3. The method of claim 1, wherein the CBR signals are transmitted in at least one line rate selected from the group consisting of: 150 Megabits per second (Mbps), 622Mbps, 2.5 gigabits per second (Gbps), 10Gbps and 40Gbps.

4. The method of claim 1, wherein the multiplexing of the CBR signals into the OTN frame comprises multiplexing four CBR signals into a single OTN frame.

5. The method of claim 4, wherein the multiplexing of said four CBR signals into said single OTN frame comprises at least one multiplexing procedure selected from the group consisting of: multiplexing four 622 Mbps CBR signals into a single OTU1 frame, multiplexing four 2.5 Gbps CBR signals into a single OTU2 frame, and multiplexing four CBR10 Gps CBR signals into a single OTU3 frame.

6. The method of claim 1, wherein the multiplexing of the CBR signals into the OTN frame comprises multiplexing sixteen CBR signals into said single OTN frame.

7. The method of claim 6, wherein multiplexing said sixteen CBR signals into said single OTN frame comprises at least one multiplexing procedure selected from the group consisting of: multiplexing sixteen 155Mbps CBR signals into a single OTU1 frame, multiplexing sixteen 622Mbps CBR signals into a single OTU2 frame, multiplexing sixteen 2.5Gbps CBR signals into a single OTU2 frame.

8. The method of claim 1, wherein said dividing OPU payload area into said TSs further comprises interleaving each of said TSs within said OPU payload area.

9. The method of claim 1, wherein said TS group includes sixteen TSs.

10. The method of claim 1, wherein allocating said TSs to said clients is executed according to a weighted allocation.

11. The method of claim 1, wherein allocating said TSs to said clients is executed according to a balanced allocation.

12. The method of claim 1, wherein step c) further comprises:
A) obtaining a value of a multi-frame alignment signal (MFAS);
B) selecting a client indexed by said value of said MFAS; and
C) inserting said CBR signal's associated overhead transported by said indexed client into an OPU overhead area.

13. The method of claim 12, wherein said MFAS is incremented for each frame.

14. The method of claim 2, wherein said justification is required in the case where an asynchronous mapping is performed.

15. The method of claim 1, wherein said mapping is selected from the group consisting of synchronous mapping, and asynchronous mapping.

16. The method of claim 1, further comprising demultiplexing the CBR signals that were multiplexed, according to the steps of:
i. finding at least one overhead associated to the CBR signal;
ii. combining data spread over a number of OTN frames, according to said at least one overhead; and
iii. affixing said at least one overhead associated with the CBR signal to a combined signal, to form a complete CBR signal.

17. A method for mapping and multiplexing constant bit rate (CBR) signals transported by means of four different clients, into a single OTN frame, said method comprising the steps of:
a) dividing an optical payload data unit (OPU) area of the OTN frame into groups of tributary slots (TSs);
b) allocating said TSs to the four different clients;
c) inserting the CBR signals' overheads into an OPU overhead area; and
d) mapping at least one byte of each of the CBR signals into said TSs allocated to said clients transporting the CBR signals.

18. The method of claim 17, further comprising, after step c):
i) determining whether a justification for compensating for data losses ,is required; and
ii) if said justification is required, performing a justification process.

19. The method of claim 17, wherein each said TSs group includes sixteen TSs.

20. The method of claim 17, wherein said CBR signals are transmitted in at least one line rate selected from the group consisting of: 150 Megabits per second (Mbps), 622Mbps, 2.5 gigabits per second (Gbps), 10Gbps and 40Gbps.

21. The method of claim 17, wherein the multiplexing of the four CBR signals into the single OTN frame comprises at least one multiplexing procedure selected from the group consisting of: multiplexing four 622Mbps CBR signals into a single OTU1 frame, multiplexing four 2.5Gbps CBR signals into a single OTU2 frame, and multiplexing four CBR10Gps CBR signals into a single OTU3 frame.

22. The method of claim 17, wherein said allocating said TSs to the four different clients requires allocating said TSs to each of the four different clients, said TSs being positioned at intervals of four TSs from each other.

23. A method for mapping and multiplexing CBR signals transported by means of sixteen different clients into a single OTN frame, said method comprising the steps of:
a) dividing the optical payload data unit (OPU) area of said OTN frame into groups of tributary slots (TSs);
b) allocating said TSs to the sixteen different clients;
c) inserting the CBR signal's associated overhead into an OPU overhead area; and
d) mapping at least one byte of each of the CBR signals into said TSs allocated to said clients transporting said CBR signals.

24. The method of claim 23, further comprising, after step c):
i) determining whether a justification for compensating for data losses is required; and
ii) if said justification is required, performing a justification process.

25. The method of claim 23, wherein each said TSs group includes sixteen TSs.

26. The method of claim 23, wherein said CBR signals are transmitted in at least one line rate selected from the group consisting of: 150 Megabits per second (Mbps), 622Mbps, 2.5 gigabits per second (Gbps), 10Gbps and 40Gbps.

27. The method of claim 23, wherein the multiplexing of the sixteen CBR signals into the single OTN frame comprises at least one multiplexing procedure selected from the group consisting of: multiplexing sixteen 155Mbps CBR signals into a single OTU1 frame, multiplexing sixteen 622Mbps CBR signals into a single OTU2 frame, and multiplexing sixteen 2.5Gbps CBR signals into a single OTU2 frame.

28. The method of claim 23, wherein allocating said TSs to the sixteen different clients requires allocating said TSs to each of the sixteen different clients, said TSs being positioned at intervals of sixteen TSs from each other.

29. A method for mapping SONET/SDH signals into an OTN frame by means of a mapper, the mapping enabling transportation of the SONET/SDH signals and the OTN frames, in a combined network architecture, said mapper executing the steps of:
a) dividing an optical payload data unit (OPU) of the OTN frame into groups of tributary slots (TSs);
b) allocating said TSs to clients transporting the SONET/SDH signals;
c) inserting associated overheads of said SONET/SDH signals into an OPU overhead area;
d) mapping at least a byte of said SONET/SDH signal into said TSs allocated to said clients transporting said CBR signals.

30. The mapper of claim 29, further comprising, after step c):
i) determining whether a justification is required; and
ii) if said justification is required, performing a justification process.

31. The mapper of claim 29, wherein said SONET/SDH signals are CBR signals.

32. The mapper of claim 29, wherein said SONET/SDH signals are transported by means of plurality of clients.

33. The mapper of claim 29, wherein said SONET/SDH signal are the defined in at least one of the SONET/SDH standards selected from the group consisting of: OC-3/STM-1, OC-12/STM-4, OC-48/STM-16, OC-192/STM-64 and OC-786/STM-256.

34. The mapper of claim 29, further enabled to perform at least one mapping function selected from the group consisting of: synchronous mapping and asynchronous mapping.

35. The mapper of claim 29, wherein said allocating said TSs to said clients is executed according to a weighted allocation.

36. The mapper of claim 29, wherein allocating said TSs to said clients is executed according to a balanced allocation.

37. The mapper of claim 29, further comprising demultiplexing the CBR signals that were multiplexed, according to the steps of:
i. finding at least one overhead associated to the CBR signal;
ii. combining data spread over a number of OTN frames, according to said at least one overhead; and
iii. affixing said at least one overhead associated with the CBR signal to a combined signal, to form a complete CBR signal.
